(19) United States
(12) Patent Application Publication
(10) Pub. No.: US 2006/0141924 A1
(43) Pub. Date: Jun. 29, 2006

(54) Stand-alone digital radio mondiale receiver device

(76) Inventors: Stefan Mende, Recklinghausen (DE); Edmund Coersmeier, Bochum (DE); Yuhuan Xu, Bochum (DE); Martin Kosakowski, Bochum (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 11/025,587

(22) Filed: Dec. 28, 2004

(51) Int. Cl. H04H 1/00; H04B 1/18

(52) U.S. Cl. 455/3.01; 455/154.1

(57) ABSTRACT

A wireless electronic device receives a digital broadcast data stream above 150 kilohertz, using a digital receiver. The device has a visual output unit for displaying or causing to be displayed a digital image or text received via the broadcast data stream. A user input device enables a user to indicate at least one selected image or text to be automatically saved, or immediately output by the visual output unit. The visual output unit may be capable of providing multimedia output such as digital services and video.

### FIELD OF THE INVENTION

The present invention relates to wireless communication, and in particular to a wireless electronic device having a visual display and wireless receiver.

### BACKGROUND OF THE INVENTION

It is known to wear a medallion attached to a necklace, and it is also known for the medallion to electronically show an image using a display. Typically, a backlight in the medallion is turned on by pressing a button, and then the device stays on for a certain limited period of time. It is also known for the medallion to be functional in more than one mode, including a repetitive mode, in which the backlight fades in and out. Instead of being fully on or fully off, the repetitive mode allows the battery to supply power over a longer total time than in the fully on mode. See, for example, co-pending application Ser. No. 10/618,074. In addition to personal accessories like medallions, other personal display devices can operate on similar principles, in order to provide a display outside the usual context of television or two-way communication. For example, these personal display devices may include devices for downloading a set of images (e.g. from a wireless telephone), and then showing the images as an electronic framed picture that can be placed on a mantle, desk, or bookshelf. These personal display devices may also include devices for downloading a set of images (e.g. from a wireless telephone), and then passing the images to a television screen or projector.

These personal display devices may have a one-way wireless link from a compatible nearby device (e.g. wireless telephone), typically for downloading the images to the personal display device. Subsequently, the personal display device can supply or display the images, after the wireless link from the compatible nearby device has ended. Thus, according to the prior art, the personal display device can receive and save image data via infrared signals from the nearby device.

A problem with such personal display devices is that they have heretofore required a compatible nearby device in order to receive the image that can then be displayed or supplied by the personal display device. Although it would be technologically possible to equip a personal display device so as to receive communications directly from a base station, the required equipment and the participation of the base station would both be inefficient and costly. Likewise, it might be technologically feasible to install a small digital television (DTV) unit into a personal display device, so as to receive a broadcast DTV signal, but the cost to the consumer would be higher than necessary.

There is a need to provide images to personal display devices without requiring nearby supporting devices such as wireless telephones or wireless base stations, and without incurring costs associated with digital television sets. Moreover, even if a way is found to successfully provide images in that way to a personal display device, there still would be a need for the user of a personal display device to exercise some choice about the types of images that are displayed.

For many decades, there has existed a public broadcasting system for delivering radio services to an audience of listeners. Both FM and AM radio have long provided free music and entertainment to the public. Recently, much progress has been made in digitizing the AM radio services, and thus improving the audio services provided to the listening audience. Digital Radio Mondiale (DRM, which is not to be confused with “digital rights management”) emerged from a meeting in Paris in 1996, between broadcasters and broadcasting equipment manufacturers. Seven years later, leading broadcasters began live, daily DRM transmissions using the AM broadcasting bands up to 30 MHz and higher. DRM has now become an international consortium of broadcasters, manufacturers, network operators, research institutions, broadcasting unions and regulatory bodies. DRM is a world standard, and therefore global travelers do not need a separate radio or radios with multiple decoders. Although it is well known to use DRM for free audio broadcasts, DRM's potential for communicating free image and other data has not been fully realized, as of yet.

The benefits of DRM for audio listeners include FM-like sound quality within the AM reach, but there are additional advantages of DRM for non-audio data recipients as well. DRM offers improved reception quality, low cost receivers, and diverse program content. For audio listeners, DRM can provide things like associated text information, station name, record title, and singer's name. In other words, DRM offers the opportunity for broadcasters to integrate data and text with their audio broadcasts, thus offering broadcasting plus datacasting, or even the opportunity to provide datacasting alone. The datacasting can be unrelated to audio, and can be in the form of textual weather forecasts or news tickers, as described in 2003: The Year of DRM's Inaugural Broadcasts (5^{th} Edition, June 2003).

Technical Details about DRM are described in Digital Radio Mondial (DRM); System Specification (ETSI ES 201 980 Version 2.1.1 (2004-06)). DRM is especially useful for communicating to large coverage areas, with little impairment caused by the environment surrounding the receiver.

The DRM transmission super frame consists of three channels: the Main Service Channel (MSC) which contains the data for services, the Fast Access Channel (FAC) for providing channel and other parameters, and the Service Description Channel (SDC) for providing information about decoding, about alternative data sources, as well as about service attributes. The MSC includes between one and four streams. Within the MSC, an audio service comprises one audio stream and optionally one data stream or one data sub-stream, whereas a data service comprises one data stream or one data sub-stream.

Thus, DRM is not only about broadcasting audio to listeners, but is also for transmitting Program Associated Data (PAD). Each data service is signaled in the SDC, so the DRM receiving software knows how to decode and display the data stream. This DRM data stream is transmitted as part of the MSC.

Of course, a DRM data service can include digital images. An example of DRM images can be seen at http://www.drmradio.co.uk/html/drm_pad_page.html (downloaded on 20 Aug. 2004), showing various images broadcast by the British Broadcasting Company's BBC World Service from Rampisham, England at 7320 kHz with Data Service 1 transmitted at 1.9 kbps.

When text and images are presented by small display screens, it is known to use source code re-authoring techniques, or use an internet domain extension for content that is specially formatted for small mobile screens, or use small screen rendering such as Opera Software (see www.opera.com/products/smartphone/smallscreen downloaded 17 Nov. 2004). Thus, technology exists to place text and images on small screens, although this technology has apparently not yet been extended to DRM text and images.

Development of new and improved DRM receivers is advancing steadily. See, for example, DRM: Progress on the Receiver Front by Peter Jackson (www.ebu.ch/trev_{—}293-jackson.pdf downloaded 21 Aug. 2004). For the mass production of consumer receivers, dedicated chips must be designed and manufactured. Only these dedicated chips can enable the production of DRM receivers with much reduced power consumption together with the lowest possible manufacturing cost. Efforts are under way to develop a dedicated DRM chipset, as described in the article by Peter Jackson, and those efforts involve more than one chip, including both an analog chip and a digital chip.

It is desirable to find a way to combine DRM with personal display devices. This would eliminate the need for nearby devices that feed images to the personal display devices, and would provide users with a free and portable access to broadcast images, using an inexpensive personal display device with very low power consumption.

The above-described scenario with DRM technology can be extended to corresponding technologies like Digital Multimedia Broadcasting (DMB), as well as Digital Video Broadcasting-Handheld (DVB-H). Europe and the United States, as well as developing countries like India and China, have decided to enable DMB and Digital AM (DRM) audio and multimedia content broadcasting today, or in the near future. Later, DVB-H will follow as well, and DVB-H is expected to be implemented in the United States using spectrum that was, for example, previously used for weather services.

However, none of those technologies have been adequately combined with personal display devices, much less with personal display devices that utilize a combination of those technologies.

These problems described above are not limited to personal display devices, and also arise in the context of other display devices, such as near eye displays (NEDs). It is known to use a biocular near to eye display (NED) as an accessory to a mobile terminal. The display content is then provided by the mobile terminal to the NED, and these two devices are connected via a cable or wireless (e.g. Bluetooth) connection. Thus, NED can be seen as eliminating difficulties caused by tiny screen sizes in the mobile terminal. In other words, placing the image near to the user's eye fills the user's angle of vision without requiring a large display.

However, NEDs have heretofore required a compatible nearby device in order to receive the image that can then be displayed or supplied by the NED. Although it would be technologically possible to equip a personal display device so as to receive communications directly from a base station, the required equipment and the participation of the base station would both be inefficient and costly. Likewise, it might be technologically feasible to install a small digital television (DTV) unit into a NED, so as to receive a broadcast DTV signal, but the cost to the consumer would be higher than necessary.

Currently, NED is not a stand-alone device, because it displays only the data provided by the terminal. In case of video games, this situation is fine, for example because often the game is installed in the terminal.

### SUMMARY OF THE INVENTION

The present invention is directed to a wireless electronic device that may, for example, be a personal display device such as a medallion, or an electronic framed picture, or a near eye display (NED), or other display device. The wireless electronic device displays (or causes to be displayed) at least one image or text that is received or controlled from a broadcast data stream, such as a DRM data stream. According to the present invention, a decoder and receiver are implemented within the personal display device. The images are provided to this receiver by a digital broadcasting band between 150 kHz and 30 MHz, and higher frequencies may be possible in the future as well. The image can be either still pictures, or images that are part of a moving presentation (i.e. video).

A first embodiment of the invention is a chip set implementation, with the analog front-end and the digital parts implemented in two different chips. Here, the analog front-end can be implemented as a single chip or is based on several components. Digital algorithms are operated on a Digital Signal Processor (DSP), Reduced Instruction Set Processor/Computer (RISC), or programmable hardware components (e.g. a Field Programmable Gate Array FPGA).

According to a second embodiment of the present invention, an AM receiver is implemented on a single embedded chip, instead of a chipset that includes more than one chip. A single chip solution is the optimum way to integrate the DRM technology into personal display devices which may be quite small, and which need to minimize power requirements. Especially if the personal display device is a medallion or other personal accessory (meaning an article of dress that completes or enhances a person's basic outfit), size and low-energy consumption are crucial factors that are addressed very well by a single chip solution.

According to a further embodiment of the present invention, the personal display device receives an MSC that includes at least one data stream or sub-stream providing a plurality of images of respective selected internet sites. The user of the personal display device is thus enabled to select from a plurality of particular internet sites, or sets of internet sites, that will be provided or displayed by the personal display device. This would be a one-way communication to the user of the personal display device, but it much of the richness of the internet does not depend upon two-way communication.

Because the display of a personal accessory will typically be quite small, an internet site will not necessarily be displayed by a personal display device in a legible and clear manner, especially if the personal display device is a personal accessory, such as a medallion. This problem can be addressed at the broadcast side, by providing a modified version of an internet site, for display on a small screen of a personal accessory. Such a broadcaster would want those internet sites to also be properly displayed by DRM receivers that have normal-sized display screens, and so an embodiment of the present invention is for the DRM broadcaster to provide both large-screen and small-screen versions of an internet site, so that the DRM receiver of a personal accessory chooses the small-screen version, whereas the DRM receiver of a larger personal display device will select the normal-screen version. The small-screen version would be analogous to the version that is already provided by some internet-capable wireless telephones. Internet sites can be presented on the small screens of personal accessories, if DRM broadcasters use source code re-authoring techniques, or use an internet domain extension for content that is formatted for a small mobile screen, or use small screen rendering (SSR). Thus, it is possible for DRM broadcasters to provide versions of an internet site and other texts/images that are suitable for display on a normal-size screen of a personal display device, as well as on smaller screens of personal display devices.

According to a further embodiment of the present invention, at least one of the images provided or controlled by the DRM signal is a moving image that accompanies music. Thus, a personal display device of any size can display an image that accompanies music, without necessarily providing the music itself. The user of the personal display device would potentially have access to another receiver in order to hear the audio part of the broadcast. It is already well known to use a personal computer in order to access internet radio, and for the personal computer to then display a moving image that moves in harmony with the audio available via the internet radio. A similar capability can be given to personal display devices, such as medallions and electronic framed pictures, and the personal display device can also provide a news ticker or the like, without necessarily providing any audio. When the user is in an environment where music broadcast by DRM is being played (or can be played) on a speaker, the user of the personal display device can adjust the user's personal display device to the frequency of the DRM music broadcast. Likewise, if the user is listening to any DRM audio broadcast, the user can utilize the personal display device to view any accompanying images and/or text, even though the personal display device is completely separate from the DRM audio receiver.

A personal display device can, in one advantageous embodiment of the present invention, be used also as a remote control to control, for example, a DRM audio receiver. Thus, if the display of a personal display device is showing text and/or images from a particular DRM broadcast, and the user also wants to hear accompanying audio, the user can press a button or the like on the personal display device, so that the personal display device will instruct a separate DRM audio receiver to tune in to the same frequency. People very frequently misplace remote control devices, and therefore a medallion, other personal accessory, or other personal display device would be a very suitable location to include such a remote control device, potentially controlling not just a DRM audio receiver, but also other devices such as television, digital video player, and the like.

When a personal display device is used to display or cause to be displayed an internet site that is broadcast via DRM, the DRM broadcaster will preferably make a variety of internet sites available, possibly with edits or re-authoring by the broadcaster. Some of the DRM-broadcasted internet sites can link to each other. For example, if one of the internet sites presents news headlines, then one of those headlines can be selectable in order to link to the internet site presenting the full news story. The user of the personal display device can press a tab button to select the next available hyperlink, and in this way the user can easily navigate to a desired hyperlink without need for a mouse, trackball, or the like (although it is possible to equip a personal display device with a cursor and with equipment for moving the cursor).

When information is provided by a DRM datacast, as opposed to an audio broadcast, the user of a personal display device can advantageously program areas of interest and/or preferences into the personal wireless device. In this way, a text or image arrives via DRM, and the personal display device can check to see if it matches the user's areas of interest and/or preferences; if not, then that data is not used by the personal display device, but if there is a match, then the data is saved or immediately presented to the user. For example, if a user gives top priority to text or images regarding a person (e.g. “Berlusconi”), and is viewing a lower priority item when a Berlusconi-related item arrives via DRM datacast, then the lower priority item is automatically removed from the display (saved for later viewing), while the Belusconi-related item is displayed. But, if the Berlusconi-related item were lower on the user's list of priorities, then it would be saved in the personal wireless device for later viewing (or automatic deletion if the user desires that some or all news stories be automatically discarded after a certain time unless the user decides otherwise). In this way, some data received via DRM can be displayed later, instead of displayed in real time, and a user can be alerted as to how many saved items are waiting to be seen by the user (i.e. displayed) for the first time.

A personal display device can thus present a great deal of text and/or images that the user has never seen before, and so this displayed data will be of interest for the user to look at, instead of being only for other people to look at. Consequently, it is desirable for a medallion or similar personal accessory to have a display that turns upside-down when the medallion is held horizontally, for example. This will prevent the user from seeing the display upside down. This kind of inversion of the displayed image and/or text can be accomplished automatically, if the personal display device includes a gravitational sensing unit, or it can be accomplished at the press of a button or the like.

### BRIEF DESCRIPTION OF THE DRAWINGS

FIG. 1 illustrates a personal accessory having a wireless electronic device, according to an embodiment of the present invention.

FIG. 2 is a flow chart illustrating an embodiment of the invention.

FIG. 3 shows a system according to an embodiment of the invention.

### DETAILED DESCRIPTION OF THE INVENTION

The international DRM consortium has developed a non-proprietary standard for the broadcast frequencies below 30 MHz, and it is expected that future releases may contain frequencies above 30 MHz. The long, medium and short wave bands provide coverage to large and remote areas, as well as in-house reception. DRM constitutes a subject of high interest to national and international broadcasters, because it improves upon analog AM by combining better sound quality with more reliable reception, plus the possibility of additional service information and data services. With that DRM technology, there is a nearly worldwide coverage available, and broadcasters can provide information, news, and music in the form of audio, text, and images.

Internet access is possible, via DRM, to certain pre-defined web-pages, in a way that is somewhat similar to existing video-text technology for television. Because broadcasting costs are paid through advertisements from industry and by governments, the internet and broadcast access via DRM is free for the user as well. DRM is seen from its members' perspective as a complementary system to Digital Audio Broadcasting (DAB) and Digital Video Broadcasting (DVB), including terrestrial (DVB-T) or handheld (DVB-H). On the one hand, the data rates are much lower, but on the other hand only a few broadcast transmitters are needed for large national or international coverage areas. Infrastructure is available and broadcasters are already providing their digital DRM programs.

Personal accessories already provide images for display by the personal accessories, and other similar devices operate on similar principles, including tasteful picture frames that display digital images, and devices that store digital images for providing them for display by a projector or television. These current devices typically receive the images from a mobile telephone or a personal computer via infrared communication. This type of connection is limited to the users of the mobile telephones or personal computers that support the interface. With the DRM radio link, however, the devices have additional freedom to access text and/or images, which is then independent of the mobile telephone or the personal computer. Therefore, more users can use these personal accessories and similar devices (collectively called personal display devices). Further, it is possible to receive via the DRM radio link a multitude of pre-defined images corresponding to an area of interest. This area of interest can be selected from a portfolio of image categories.

For personal display devices having a sufficiently large display area, the DRM radio link can be used to display detailed news services, flight schedules or traffic information. Further, pre-defined web pages can be displayed with that DRM technology. The radio link is free of charge, and will have a worldwide coverage in the near future.

A single chip solution for the DRM receiver has been evaluated by the present inventors, and this solution offers very significant cost savings. This single chip includes its own analog front-end. Because of the single chip solution, it is possible to integrate this technology into the existing personal display device products. As mentioned above, chip-set implementation based on a separate analog front-end and DSP/RISC/FPGA is possible as well.

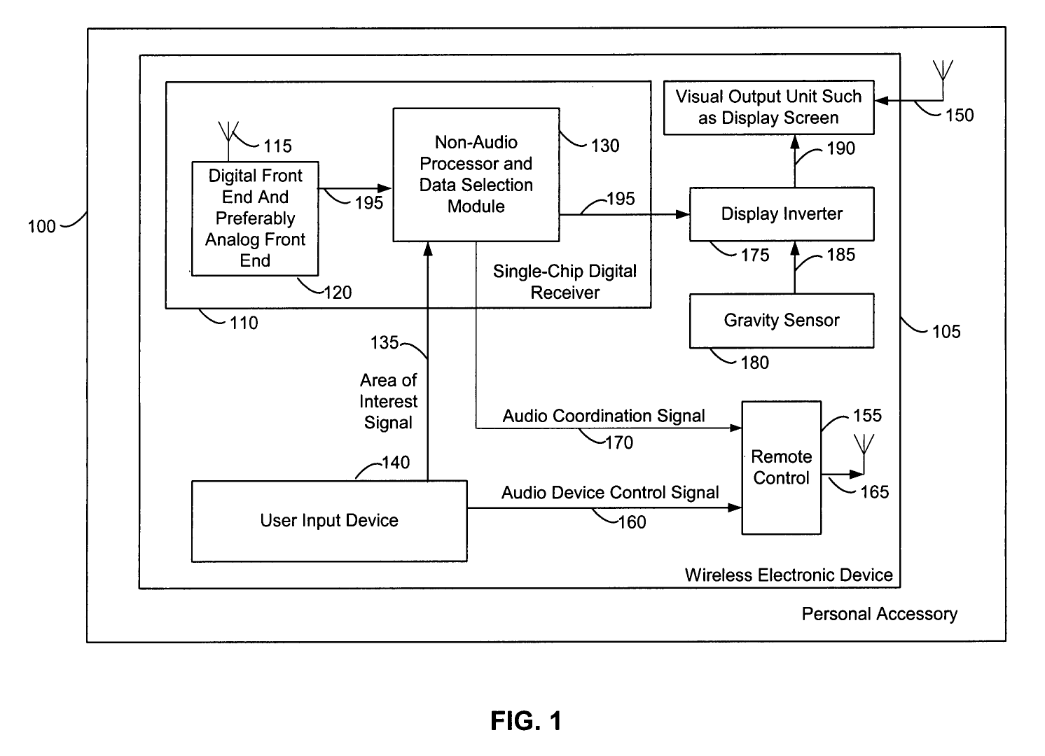

Referring now to FIG. 1, a personal accessory 100 is equipped with a wireless electronic device 105. The personal accessory may be, for example, a medallion to be worn around a person's neck. Within the wireless electronic device, a single-chip digital receiver 110 is for receiving a broadcast data stream via an antenna 115. The broadcast data stream initially is handled by a front end 120, which may include both an analog front end and a digital front end, all within the single-chip 110. The digital front end then provides the data in a data signal 125 to a non-audio processor and data selection module 130. The data selection includes selecting an image or text that conforms to a user's area of interest 135 expressed using a user input device 140, and may also include selecting a version of that image or text in order to conform with the size of a display screen 145 (e.g. both a small-screen version and a big-screen version may be broadcast). Additional text or images can be provided to the display screen 145 via a wireless connection 150 that operates over a short range from another device belonging to the user, such as the user's wireless telephone.

This embodiment includes a remote control 155, responsive to an audio device control signal 160 from the user, for communicating via a wireless connection 165 with an audio device that can provide audio to accompany the visual material provided by the display screen 145. Instead of the user having to indicate the channel, frequency, and other data related to the visual material provided by the display screen 145, those details can be automatically provided in an audio coordination signal 170 from the receiver 110, so that the user effort to provide the audio device control signal 160 will be minimal.

This embodiment also includes a display inverter 175. The purpose of this unit is to turn the displayed image (or text) upside down when the medallion is being viewed by the person wearing the medallion, instead of being viewed by another person. When a person wishes to view the medallion that is hanging around the person's neck, the person will normally lift the medallion from a roughly vertical position to another position (e.g. horizontal). This changed orientation is easily sensed by a gravity sensor 180 which reports 185 to the display inverter 175. If the gravity sensor does not sense any significant change in orientation, then the display inverter merely passes through a signal 190 that is the same as the signal 195 from the receiver. Of course, embodiments are possible in which the antennas 115, 150, and 165 can be consolidated into one antenna.

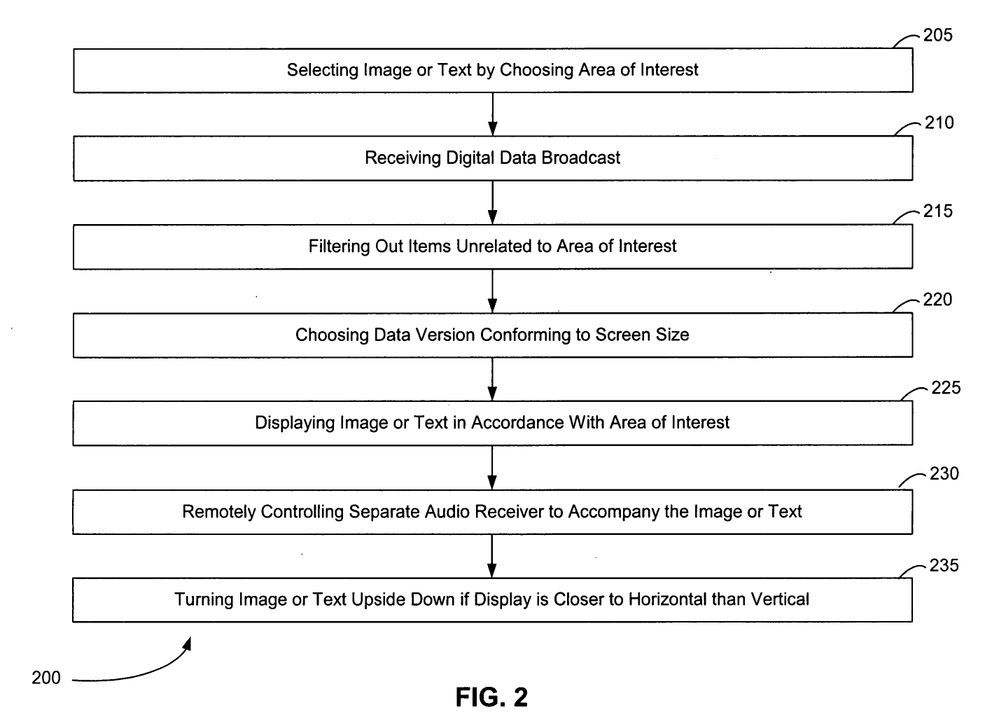

Turning now to FIG. 2, this is a flow chart showing how the method 200 will work, in one embodiment of this invention. The first step is selecting 205 an image or text by choosing an area of interest, and this may be accomplished, for example, by choosing a keyword, or by selecting from various standard options. The next step is receiving 210 a digital data broadcast, and then filtering out 215 items unrelated to the chosen area of interest. The next step is for the user, or for the wireless electronic device worn by the user, to choose 220 a data version conforming to screen size, so that, if the broadcaster is making available a version specially formatted for small screens then that version will be chosen. The next steps are displaying 225 the image or text in accordance with the area of interest, and optionally remotely controlling 230 a separate audio receiver to accompany the image or text. A further option is to turn 235 the image or text upside down if the display is closer to horizontal than vertical (e.g. signifying that the user, instead of another person, is attempting to view a small screen worn around the user's neck).

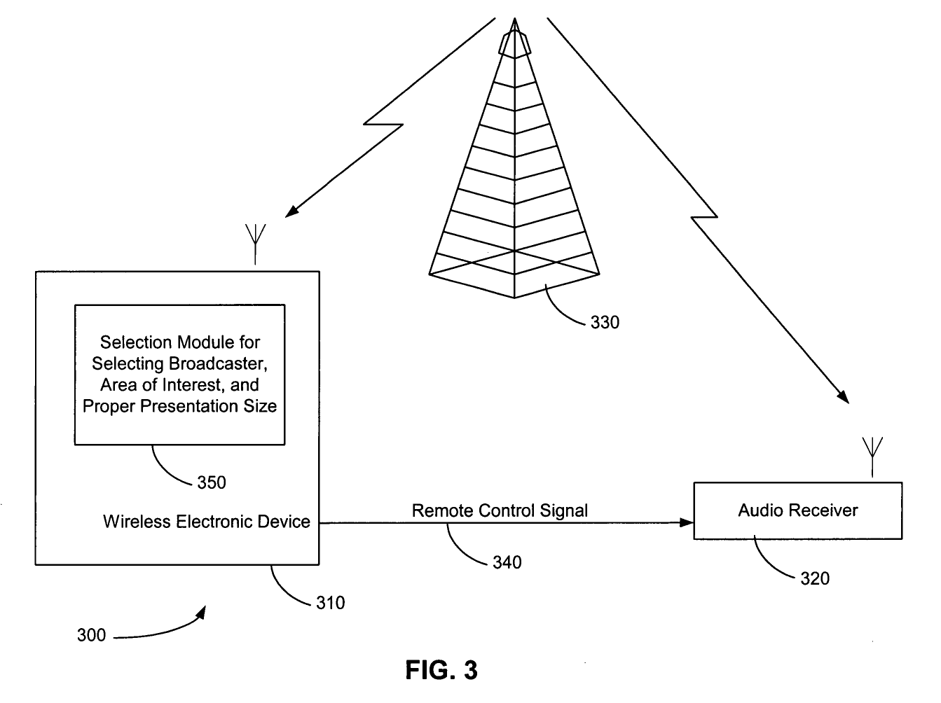

FIG. 3 shows a system 300 according to an embodiment of the present invention. The broadcaster 330 emits a signal that is picked up by both a wireless electronic device 310 as well as an audio receiver 320. The wireless electronic device 310 is worn by the user and presents only visual output, whereas the audio receiver 320 is located apart from the user and can provide audio to accompany the visual output of the wireless electronic device 310. Thus, if the user believes, based upon the visual output of the wireless electronic device, that accompanying audio would be desirable, then the user will cause the device to send a remote control signal 340 to the audio receiver. Even if the wireless electronic device 310 is operated without the audio receiver 320, the wireless electronic device has a selection module 350 giving the user capability to select a broadcaster (e.g. a radio station), select an area of interest so that only relevant visual output will be presented to the user, and select a proper presentation size so that the visual output will be formatted at the broadcast side to fit small display screens.

The embodiments described above can be modified by using a NED wireless electronic device having its own receiver for DMB, Digital AM (DRM), and DVB-H signal reception. This leads to a visual device, or even a multimedia device, that is independent of any mobile terminal, and operates even if two of those three types of broadcast are unavailable. Thus, the present invention is applicable to DRM, DAB, DMB, and DVB-H that involve a digital data broadcast above 150 kilohertz.

All three technologies of those broadcast methods allow low power receivers, can deliver visual and multimedia content, and are independent of operator networks. The broadcasters can offer speech, music, image and video information for different purposes, and NED becomes the mobile device to combine all of this information, in a very compact manner near the user's eyes, regardless of whether the user is carrying a mobile terminal.

Digital AM (i.e. DRM) is complementary technology compared with DMB and DVB-H, because it addresses a very large area (countrywide), but provides low data rate multimedia content. DMB and DVB-H reach a small area for each transmitter (about a 50 km range), but they enable high data rate services. Thus, a typical user would find advantages in having not just DRM available at a particular location, but also at least one of these other services as well, so that the user can access different types of free content.

For example, advertisers will be especially interested in the combination of Digital AM (DRM) and NED, because the products for sale can be displayed in short video clips and do not require long videos, and additionally Digital AM reaches a huge mass of people. In contrast, performances and the like would probably prefer DMB or DVB-H because of the higher data rates; DMB and DVB-H are more useful for video transmission and video on demand. A dense coverage of transmitters or repeaters provides an opportunity to distribute different videos to different customers within relatively small cells, instead of using DRM. Having all of these options (DRM and also DMB and/or DVB-H) available in a single NED, or in a single medallion or other personal accessory, will be highly useful instead of requiring separate devices for these separate services.

Again, a key to successful, compact, and affordable implementation will be using a single chip for digital processing. The single chip may contain not just a visual image (e.g. video) generator, but also may have audio capability, including an audio amplifier. If the wireless electronic device is a NED, then the user interface can be a button interface on the headset. In certain cases, a Bluetooth link to a phone or extra keyboard can be used as well; in case of a Bluetooth link, no payload is transmitted from the terminal or keyboard to the headset, but only control commands from the user to the headset.

Advantages of enhancing NED with wireless receivers for DMB, Digital AM and DVB-H include the following. NED is terminal independent, and can therefore be used as a stand-alone device. No operator or network is needed, except for a free broadcast service. These same advantages apply also to personal accessories such as electronic medallions, and to personal display devices such as electronic picture frames.

It is to be understood that all of the present figures, and the accompanying narrative discussions of best mode embodiments, do not purport to be completely rigorous treatments of the invention under consideration. A person skilled in the art will understand that the steps described herein represent general cause-and-effect relationships that do not exclude intermediate interactions of various types, and will further understand that the various components and structures described herein can be implemented by a variety of different combinations of hardware and software which need not be further detailed.

What is claimed is:

1. A wireless electronic device for receiving at least a digital data broadcast above 150 kilohertz, comprising:
a receiver for receiving a digital broadcast data stream or data sub-stream within a main service channel of the digital data broadcast;
a visual output unit for displaying or causing to be displayed at least one digital image or text received via the broadcast data stream; and
a user input device for indicating at least one selected image or text to be automatically saved or output by the visual output unit,
wherein the digital receiver is a single-chip receiver having all front end components on a single chip and having no audio interface or audio decoder,
wherein the single-chip digital receiver comprises a dedicated chipset for digital data broadcast reception above 150 kilohertz, said dedicated chipset having only said single chip.

2. The wireless electronic device of claim 1,
wherein the user input device is for indicating the at least one selected image or text by permitting the user to select an area of interest, and
wherein the wireless electronic device is equipped to filter out items unrelated to the area of interest.

3. The wireless electronic device of claim 1, wherein the wireless electronic device is part of a personal accessory.

4. The wireless electronic device of claim 1, wherein the wireless electronic device is part of a near to eye display.

5. The wireless electronic device of claim 1, wherein the wireless electronic device is equipped for receiving the digital data broadcast as a digital multimedia broadcast (DRM) or digital video broadcast for handheld (DVB-H), in addition to being for receiving the digital data broadcast as a digital radio mondiale (DRM) broadcast.

6. The wireless electronic device of claim 3, further comprising a display inverter for displaying or causing to be displayed the at least one digital image or text to a user wearing the personal accessory,
wherein the personal accessory is a medallion, and
wherein the display inverter is for use at least when the medallion is held in a horizontal position.

7. The wireless electronic device of claim 6, wherein the display inverter operates automatically upon sensing an orientation or type of movement of the personal accessory.

8. The wireless electronic device of claim 1, further comprising a selection module for selecting a received version of the at least one digital image or text that conforms to an image presentation size of the wireless electronic device.

9. The wireless electronic device of claim 1, wherein the wireless electronic device is a biocular near to eye display (NED) for being worn used within six inches of a user's eyes.

10. The wireless electronic device of claim 1, further comprising a remote control, for remotely controlling a separate audio receiver that offers audio content to optionally accompany the at least one digital image or text.

11. The wireless electronic device of claim 10, wherein activation of the remote control causes the separate audio receiver to automatically tune in to an audio stream corresponding to the at least one digital image or text.

12. The wireless electronic device of claim 11, wherein the visual output unit is for displaying or causing to be displayed a moving image that mimics cadences of the audio content.

13. The wireless electronic device of claim 1, wherein the visual output unit is also for displaying or causing to be displayed a further plurality of images or texts loaded from another device that is operable by the user of the wireless electronic device.

14. The wireless electronic device of claim 1,
wherein the at least one selected image or text is selected by use of at least one keyword.

15. The wireless electronic device of claim 1,
wherein at least two of the at least one digital image or text are linked by a hyperlink, and
wherein the wireless electronic device includes an activator for activating the hyperlink in response to user input.

16. The wireless electronic device of claim 1, wherein if the at least one digital image or text is automatically saved, with or without being immediately output by the visual output unit, then a time and date is recorded when the at least one digital image or text is automatically saved.

17. The wireless electronic device of claim 16, wherein the time and date are useable for automatic deletion of older images or texts including news, flight schedules, or traffic information that was received more than a certain time ago, absent a non-deletion order from the user.

18. A system comprising:
a wireless electronic device that is at least for receiving at least one digital image or text that is broadcast above 150 kilohertz;
a separate audio receiver that offers audio content to optionally accompany the at least one digital image or text,
wherein the wireless electronic device includes a remote control for remotely controlling the separate audio receiver.

19. A method comprising:
selecting at least one image or text to be automatically saved or output to at least one viewer;
receiving at least a digital data broadcast above 150 kilohertz, and
saving, displaying, or causing to be displayed at least one digital image or text received via the digital data broadcast, in accordance with the at least one image or text that has been selected.

20. The method of claim 19, further comprising the step of choosing a received version of the at least one digital image or text that conforms to an image presentation size.

21. The method of claim 19, further comprising the step of remotely controlling a separate audio receiver that offers audio content to optionally accompany the at least one digital image or text.

22. A computer readable medium encoded with a software data structure sufficient for performing the method of claim 19.

23. The method of claim 19, wherein the at least one image or text is output from a near to eye display located within six inches of a user's eyes.

24. The method of claim 19, wherein the digital data broadcast above 150 kilohertz is a digital radio mondiale broadcast, and wherein the digital data broadcast is later received as a digital multimedia broadcast (DRM) or digital video broadcast for handheld (DVB-H).

25. A system comprising:
a wireless electronic device that is at least for receiving at least one digital image or text that is broadcast above 150 kilohertz; and
a broadcast apparatus for sending the broadcast,
wherein the at least one digital image or text contained in the broadcast are categorized among a plurality of pre-defined areas of interest that are selectable at the wireless electronic device, and
wherein the broadcast further include a plurality of versions of the at least one digital image or text that conform to respective possible image presentation sizes of the wireless electronic device.

26. A wireless electronic device for receiving at least a digital data broadcast above 150 kilohertz, comprising:
a digital receiver for receiving a broadcast data stream or data sub-stream within a main service channel of the digital data broadcast;
a visual output unit for displaying or causing to be displayed at least one digital image or text received via the broadcast data stream; and
a user input device for indicating at least one selected image or text to be automatically saved or output by the visual output unit,
wherein digital algorithms are operated on one, or a combination of, a digital signal processor, a reduced instruction set computer or processor, and programmable hardware components, and
wherein an analog front-end is implemented separately from a chip that implements a digital algorithm.
